(19) United States
(12) Patent Application Publication
(10) Pub. No.: US 2014/0193992 A1
(43) Pub. Date: Jul. 10, 2014

(54) ELECTRICAL CONNECTOR HAVING IMPROVED SHILEDING PLATE

(71) Applicant: HON HAI PRECISION INDUSTRY CO., LTD., New Taipei (TW)

(72) Inventors: AI-HONG FANG, Kunshan (CN); HUO-XING JIN, Kunshan (CN)

(73) Assignee: HON HAI PRECISION INDUSTRY CO., LTD., New Taipei (TW)

(21) Appl. No.: 14/150,787

(22) Filed: Jan. 9, 2014

(30) Foreign Application Priority Data
Jan. 9, 2013 (CN) 201310007481.4

(51) Int. Cl. H01R 13/6591

(52) U.S. Cl. CPC H01R 13/6591
USPC 439/345

(57) ABSTRACT

An electrical connector includes an insulative housing, a plurality of contacts retained in the housing, and a shielding attached to the housing. The housing defines a bottom wall, two opposite side walls, two end walls, and a mating tongue disposed in a mating cavity surrounded by the side walls and end walls. The plurality of contacts is arranged in the mating tongue and includes a grounding contact having a soldering portion thereof. The shielding plate defines a soldering leg having a receiving slot therein, the soldering portion passes through the receiving slot to extend out of the housing, which is propitious to make soldering pads of the electrical connector disposed in a same planar and is suitable for miniaturization.

### BACKGROUND OF THE INVENTION

1. Field of the Invention

The present invention relates to an electrical connector, and more particular to an electrical connector having an improved shielding plate which is propitious to make soldering pads of the electrical connector disposed in a same planar and is suitable for miniaturization.

2. Description of the Related Art

U.S. Pat. No. 6,464,515 issued on Oct. 15, 2002 discloses an electrical connector including a housing, a plurality of contacts retained to the housing, and a shielding member attached to an outer surface of a side wall of the housing. The plurality of contacts includes a grounding contact having a retaining portion thereof, the shielding member contacts with the retaining portion and is clipped between the retaining portion and the side wall, which can get a good electrical connection between the grounding contact and the shielding member and further to prevent the shielding member from breaking away from the housing. However, the grounding contact may be deformed while abutting against the shielding member, and the soldering portion of the grounding contact may be disposed in a planar that different from the planar in which the soldering legs of other contacts disposed, which is not good for soldering of the electrical connector.

Chinese Pat. No. 2689500Y issued on Mar. 30, 2005 discloses another electrical connector having a shielding member and a plurality of contacts. The soldering legs of the contacts are arranged in two rows, and the shielding member defines several soldering portions set between the soldering legs in each row, the soldering legs and the soldering portions can be disposed in a same planer. However, the soldering portions of the shielding member may expense lots of space, which is not benefit for miniaturization.

Therefore, a new design is required.

### SUMMARY OF THE INVENTION

Accordingly, an object of the present invention is to provide an electrical connector having an improved shielding plate which can make soldering pads of the electrical connector disposed in a same planar and is suitable for miniaturization.

In order to achieve the object set forth, an electrical connector includes an insulative housing, a plurality of contacts retained to the housing, and a shielding plate attached to the housing. The housing defines a bottom wall, two opposite side walls projecting from the bottom wall in a mating direction and extending in a longitudinal direction, two end walls respectively connecting the side walls at longitudinal ends thereof, and a mating tongue disposed in a mating cavity surrounded by the side walls and end walls. The plurality of contacts is arranged in the mating tongue along the longitudinal direction and partly projects into the mating cavity, the plurality of contacts includes a grounding contact having a soldering portion thereof. The shielding plate defines a soldering leg having a receiving slot therein, the soldering portion of the grounding contact passes through the receiving slot to extend out of the housing.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector in accordance with the present invention;

FIG. 2 is another perspective view of the electrical connector shown in FIG. 1;

FIG. 3 is an exploded perspective view of the electrical connector shown in FIG. 1;

FIG. 4 is another exploded perspective view of the electrical connector shown in FIG. 3;

FIG. 5 is an amplificatory portion in the circle A shown in FIG. 1; and

FIG. 6 is an amplificatory portion in the circle B shown in FIG. 2.

### DETAILED DESCRIPTION OF THE INVENTION

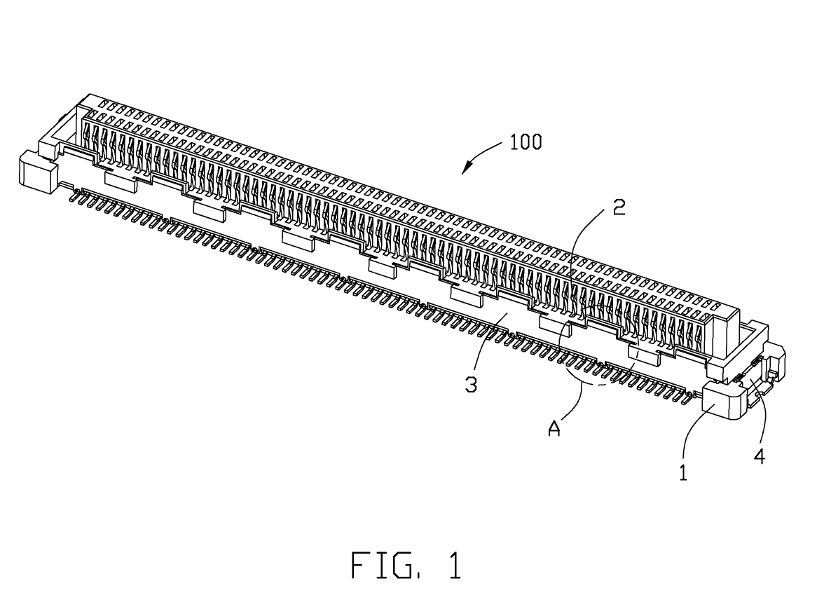

Reference will now be made to the drawing figures to describe a preferred embodiment of the present invention in detail. Referring to FIG. 1, the electrical connector 100 includes a longitudinal insulative housing 1, a plurality of contacts 2 retained in the housing 1, a pair of shielding plate 3 retained to opposite side of the housing 1, and a pair of metal ear 4 retained at two opposite ends of the housing 1 respectively.

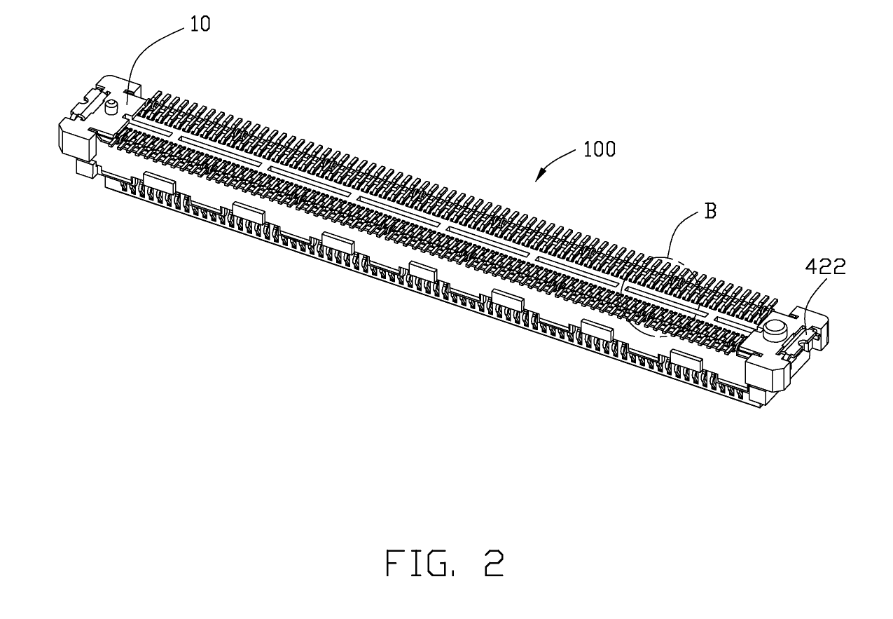

Referring to FIG. 2 to FIG. 4, the longitudinal housing 1 includes a bottom wall 10, a pair of side wall 11 upwardly projecting from the bottom wall 10 and extending along a longitudinal direction, a pair of end wall 12 opposite to each other and connecting with two ends of the side walls 10, and a mating tongue 13 upwardly projecting from a middle portion of the bottom wall 10 and disposed in a mating cavity 14 surrounded by the side walls 11 and end walls 12. Each side wall 11 defines several latching portions 110 projecting outwardly from an outer side face thereof and arranged in one row, each latching portion 110 defines two opposite latching slots 111 at two opposite sides thereof. The housing 1 defines four fixing slots 15 each at a joint of the side wall 11 and the end wall 12. Each end wall 12 defines a receiving space 120 running through the upper face and bottom face thereof, and the receiving space 120 includes a retaining slot 121 and a guiding slot 122 adjacent to the retaining slot 121. The mating tongue 13 defines a plurality of passageways 16 extending in a mating direction and running through the bottom wall 10 thereof, the plurality of passageways 16 arranged in the longitudinal direction and disposed at opposite side face of the mating tongue 13.

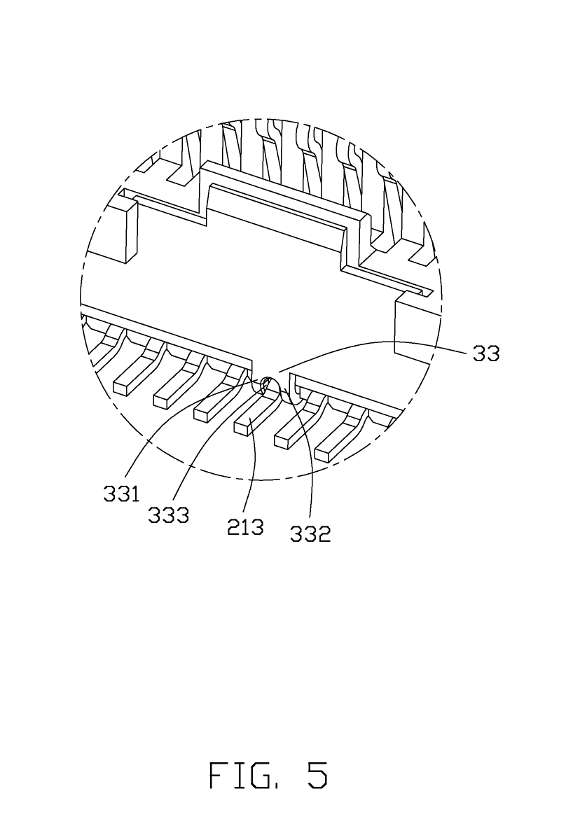

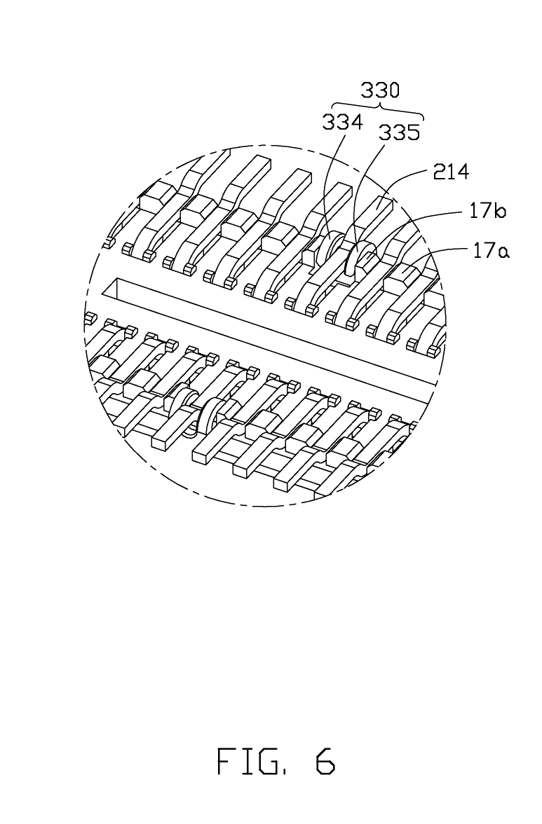

Referring to FIG. 2 to FIG. 6, each shielding plate 3 defines a planar shielding portion 31, a plurality of latching pieces 32 upwardly extending from the shielding portion 31, and a plurality of soldering legs 33 bending from the a lower side of the shielding portion 31. Each soldering leg 33 is a fork-shaped and defines a first soldering portion 331 and a second soldering portion 332 separated from each other, a receiving slot 333 is provided between the first soldering portion 331 and the second soldering portion 332. The first soldering portion 331 defines an arc-shaped first soldering face 334, and the second soldering portion 332 defines an arc-shaped second soldering face 335, the first and second soldering faces 334, 335 are combined as an arc-shaped soldering face 330 of the soldering leg 33. The shielding plates 3 are upwardly attached to the outer side face of the side wall 11 and retained to the housing 1 by the latching pieces 32 latching with the corresponding latching slots 111, the end portions of each shielding plate 3 are retained to the fixing slots 15, and the plurality of the soldering leg 33 are disposed under the housing 1. The arc-shaped soldering face 330 is benefit for the distributing of the soldering material on the soldering leg 33 while melting, which can improve the soldering effect between the soldering legs 33 and the printed circuit board. The soldering legs 33 are disposed under the housing 1 to reduce the room expended on the printed circuit board, which is benefit for minimization of the electrical connector 100.

The plurality of contacts 2 are arranged in two rows along the longitudinal director and include grounding contacts 21 and signal contacts. The grounding contacts 21 and signal contacts have similar structure and each defines a fixing portion 211, a contacting arm 212 upwardly extending from the fixing portion 211, and a soldering portion 213 outwardly extending from the fixing portion 211 and defining a soldering surface 214 thereof. The plurality of contacts 2 are upwardly assembled to the passageways 16 from the bottom wall 10 thereof and retained in the passageways 16 by the fixing portions 211 engaging with the housing 1, the contacting arms 212 project into the mating cavity 14 form opposite side face of the mating tongue 13, and the soldering portions 213 extend out of the side wall 11.

Each soldering leg 33 of the shielding plate 3 corresponds to a soldering portion 213 of the grounding contact 21, the soldering portion 213 passes through the corresponding receiving slot 333 and is disposed between the first soldering portion 331 and the second soldering portion 332. Each soldering leg 33 does not contact with the corresponding soldering portion 213, which can prevent the soldering portion 213 of the grounding contact 21 from deforming by being pushed so as to make the soldering portions 213 of the contacts 21 all disposed in a same planar. The separated soldering leg 33 and the corresponding soldering portion 213 can be connected by melted soldering material while the electrical connector 100 being soldered to the printed circuit board, which can provide a good grounding function. Synchronously, each soldering leg 33 and the corresponding soldering portion 213 overlap with each other in the mating direction, which can save the space of the printed circuit board that the electrical 100 expensed. Each soldering surface 214 offsets with a corresponding soldering face 330 in a transverse direction perpendicular to the mating direction and the longitudinal direction, which can prevent the soldering leg 33 from contacting with other contacts disposed adjacent to the corresponding grounding contact 21.

The bottom wall 10 defines first and second rib portions 17a, 17b projecting from the bottom face thereof and arranged side by side for spacing adjacent soldering portions of the contacts 21, the width of the second rib portion 17b in the longitudinal direction is smaller than the width of the first rib portion 17a that disposed in the longitudinal direction, so that the space provided between two adjacent second rib portions 17b is big enough to receive the soldering portion 33 and the corresponding soldering leg 213 therein.

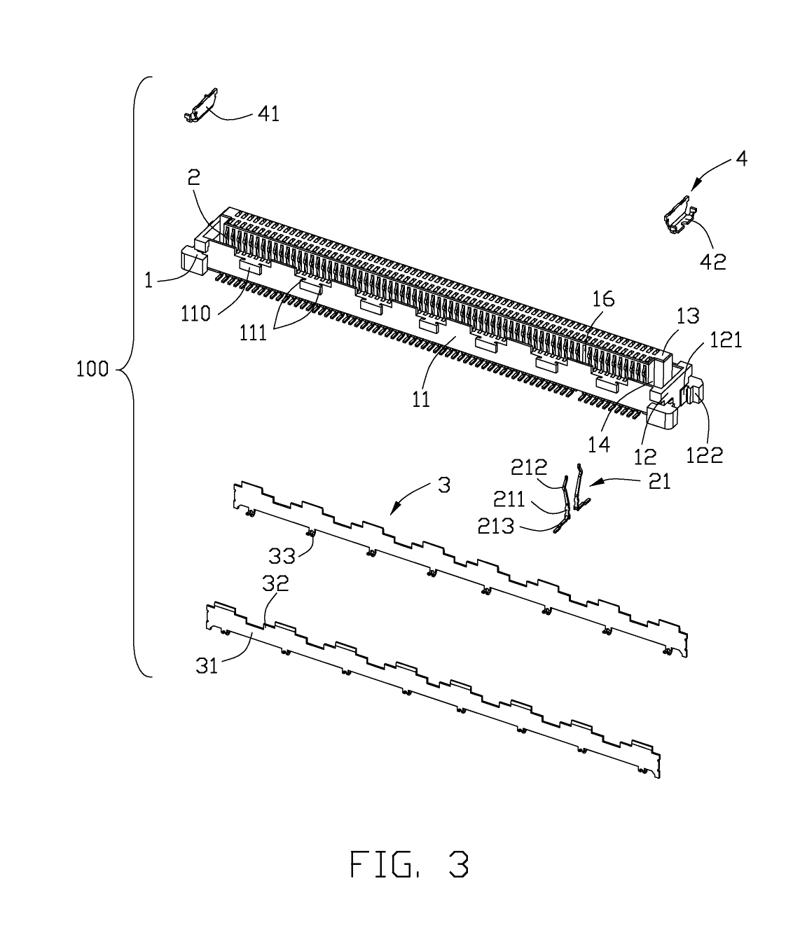

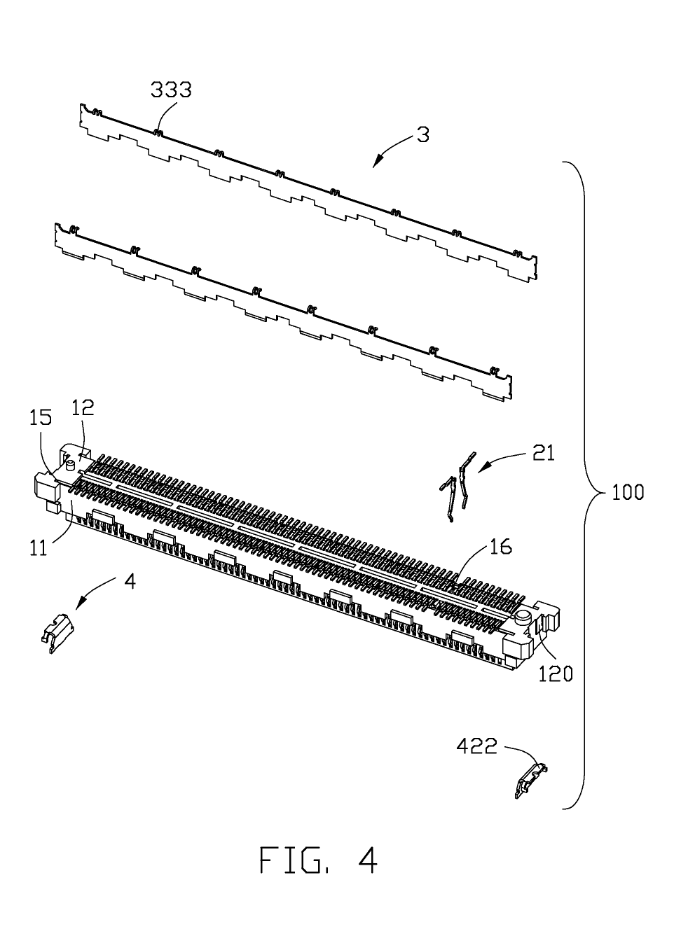

Referring to FIG. 1, FIG. 3 and FIG. 4, each metal ear 4 defines a retaining plate 41 and a soldering plate 42 bending from a lower end of the retaining plate 41 and extending in the longitudinal direction. The soldering plate 42 defines a pair of guiding portion 421 extending from two opposite side ends thereof and extending in the transverse direction. The metal ears 4 are downwardly assembled into the receiving room 120 by the guiding portions 421 gliding in the guiding slot 122 until the retaining plate 41 fixed in the retaining slot 121. The guiding portions 421 can make the assemblage of the metal ear 4 smoothly; moreover, the arc-shaped soldering side 422 is benefit for the distributing of the soldering material while melting.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector, comprising:
an insulative housing defining a bottom wall, two opposite side walls projecting from the bottom wall in a mating direction and extending in a longitudinal direction, two end walls respectively connecting the side walls at longitudinal ends thereof, and a mating tongue disposed in a mating cavity surrounded by the side walls and end walls;
a plurality of contacts arranged in the mating tongue along the longitudinal direction and partly projecting into the mating cavity, the plurality of contacts comprising a grounding contact having a soldering portion thereof; and
a shielding plate attached to an outer face of the side wall;
wherein the shielding plate defines a soldering leg having a receiving slot therein, the soldering portion of the grounding contact passes through the receiving slot to extend out of the housing.

2. The electrical connector as described in claim 1, wherein the soldering portion of the grounding contact does not contact with the soldering leg of the shielding plate.

3. The electrical connector as described in claim 1, wherein the soldering portion of the grounding contact overlaps with the soldering leg of the shielding plate in the mating direction.

4. The electrical connector as described in claim 3, wherein the soldering leg of the shielding plate is a fork-shaped and defines a first soldering portion and a second soldering portion separated from the first soldering portion, the receiving slot is provided between the first and second soldering portions, the soldering portion of the grounding contact passes through the receiving slot and disposed between the first and second soldering portions.

5. The electrical connector as described in claim 4, wherein the soldering portion of the grounding contact defines a soldering face, and the soldering leg of the shielding plate defines a soldering surface, the soldering surface is closer to the side wall than that of the soldering face in a transverse direction perpendicular to the mating direction and the longitudinal direction.

6. The electrical connector as described in claim 5, wherein the soldering surface of the shielding plate is an arc-shaped.

7. The electrical connector as described in claim 6, further defining a metal ear retained in the end wall.

8. The electrical connector as described in claim 7, wherein the metal ear defines a board-shaped retaining plate and a soldering plate bending from a lower end of the retaining plate and extending in the longitudinal direction, the soldering plate defines an arc-shaped soldering side.

9. The electrical connector as described in claim 8, wherein the soldering plate defines a pair of guiding portion extending from two opposite side edges thereof and extending in the transverse direction.

10. The electrical connector as described in claim 9, wherein each end wall defines a receiving space running through an upper face and bottom face thereof, the metal ear is retained in the receiving space.

11. The electrical connector as described in claim 10, wherein the receiving space includes a retaining slot and a guiding slot adjacent to the retaining slot, the guiding portions glide in the guiding slot until the retaining plate fixed in the retaining slot while the assemblage of the metal ear.

12. The electrical connector as described in claim 11, wherein the bottom wall defines first and second rib portions projecting from a bottom face thereof and arranged side by side, the width of the second rib portion disposed in the longitudinal direction is smaller than the width of the first rib portion that disposed in the longitudinal direction, so that the soldering portion and the corresponding soldering leg can be arranged between two adjacent second rib portions.

13. An electrical connector, comprising:
an insulative housing defining two opposite side walls extending in a first direction and a second direction;
two rows of contacts arranged in the housing along the second direction and comprising soldering portions extending out of the opposite side walls along a third direction perpendicular to the first and second directions, each row of contacts comprising grounding contacts therein; and
a shielding plate attached to and covering an outer face of each side wall, the shielding plate defining soldering legs;
wherein the soldering legs of the shielding plate each defines a receiving slot therein, the soldering portion of each grounding contact passes through the receiving slot to extend out of the housing.

14. The electrical connector as described in claim 13, wherein each soldering leg of the shielding plate is a fork-shaped and defines a first soldering portion and a second soldering portion separated from the first soldering portion, the receiving slot is provided between the first and second soldering portions, the soldering portion of each grounding contact is disposed between the first and second soldering portions.

15. An electrical connector comprising:
an elongated insulative housing with a pair of side walls extending along a longitudinal direction while being opposite to each other in a transverse direction perpendicular to said longitudinal direction, each of said side walls defining an exterior surface along said longitudinal direction;
a plurality of contacts disposed in the housing, each of said contacts including an upper contacting section generally extending upwardly in a vertical direction perpendicular to both said longitudinal direction and said transverse direction, and lower soldering section generally extending in the transverse direction for surface-mounting to a printed circuit board, said contacts being categorized with signal and grounding contacts;
a plurality of latching portions formed on the exterior;
a pair of metallic shielding plates attached upon the exteriors of the corresponding side walls, respectively, each of said shielding plates being configured to be allowed to be assembled to the corresponding side wall only upwardly in the vertical direction, and defining a plurality of upper latching sections secured to the corresponding latching portions, respectively, and a plurality of lower latching sections grasping a bottom side of the housing; wherein
the lower latching section is electrically contacted with the corresponding grounding contact in the longitudinal direction after the electrical connector mounted to the printed circuit board.

16. The electrical connector as claimed in claim 15, wherein the upper latching sections and the lower latching sections are alternately arranged with each other along said longitudinal direction.

17. The electrical connector as claimed in claim 15, wherein said lower latching sections are arranged with pairs each sandwiching the corresponding grounding contact along the longitudinal direction in a balanced manner.

18. The electrical connector as claimed in claim 17, wherein each pair of the lower latching sections defines a receiving slot through which the lower soldering section of the corresponding grounding contacts outwardly extends in the transverse direction.

19. The electrical connector as claimed in claim 15, wherein the lower latching section is located adjacent to the lower soldering section of the corresponding grounding contact.

20. The electrical connector as claimed in claim 15, wherein the housing defines a plurality of ribs on the bottom side to snugly separate the lower soldering sections of the corresponding neighboring contacts, and each of the ribs beside the grounding contacts is narrower than that beside the signal contacts so as to leave a space to allow the lower latching section of the shielding plate to be intimately disposed beside the lower soldering section of the corresponding grounding contact.
